(19) United States
(12) Patent Application Publication
(10) Pub. No.: US 2026/0220120 A1
(43) Pub. Date: Jul. 30, 2026

(54) MECHANISMS FOR TRACKING DATABASE RECORD LINEAGE

(71) Applicant: Salesforce, Inc., San Francisco, CA (US)

(72) Inventors: Christopher Drexelius, San Jose, CA (US); Thomas Fanghaenel, Oakland, CA (US); Terry Chong, Pleasanton, CA (US); Vaibhav Arora, San Francisco, CA (US); Ankit Sharma, Toronto (CA)

(21) Appl. No.: 19/041,655

(22) Filed: Jan. 30, 2025

(51) Int. Cl. G06F 16/23

(52) U.S. Cl. CPC G06F 16/2358

(57) ABSTRACT

A log owner of a database system may receive a request from a log tailer of the database system to log a database operation in a transaction log. The log owner maintains the transaction log and the log tailer replays the transaction log. The request includes a record resulting from the database operation, and the record includes lineage information identifying a first previous version of the record observed by the log tailer when generating the record. The log owner then detects whether a record violation has occurred where a second previous version of the record has been committed that is a newer version than the first previous version. In response to detecting that the record violation occurred, the log owner prevents the database operation from being logged in the transaction log and may return an error to the log tailer that pertains to the record violation.

### BACKGROUND

### Technical Field

This disclosure relates generally to database systems and, more specifically, to various mechanisms for tracking database record lineage.

### Description of the Related Art

Enterprises routinely implement database management systems (or, simply “database systems”) that enable users to store data in an organized manner that can be efficiently accessed and manipulated. A database system may implement any of various types of databases to store data, such as a relational database, a non-relational database, etc. During operation, a database system receives requests from users via client applications or from other systems, such as other database systems, to perform database transactions on the data that is stored in the database of the database system. A database transaction can comprise various database statements defining operations that involve reading data from the database and/or writing data to the database. For example, the database system may receive a structured query language (SQL) update statement to update an existing record of a database table of the database.

### BRIEF DESCRIPTION OF THE DRAWINGS

FIG. 1 is a block diagram illustrating one embodiment of a system that comprises a log owner and a log tailer.

FIGS. 2A and 2B are block diagrams illustrating one example in which a record violation is detected by a log owner.

FIG. 3 is a block diagram illustrating one embodiment that pertains to persisting lineage information during a compaction operation on a log-structured merge tree (LSM tree).

FIG. 4 is a block diagram illustrating one embodiment that pertains to tracking database record lineage across multiple records generated for the same key by the same transaction.

FIG. 5 is a block diagram illustrating one example in which a record lineage ends and a new record lineage begins.

FIG. 6 is a flow diagram illustrating an example method pertaining to detecting a record violation based on lineage information.

FIG. 7 is a block diagram illustrating elements of a computer system for implementing various systems described in the present disclosure, according to some embodiments.

### DETAILED DESCRIPTION

Many database systems implement a leader-follower architecture in which a cluster of database nodes includes a leader node (herein referred to as the “log owner” or “primary node”) and one or more follower nodes (herein referred to as the “log tailers,” “secondary nodes,” or “replica nodes”). In this architecture, the log owner maintains a transaction log that describes database operations (e.g., inserts, updates, and deletes) performed within the database system. As such, the log owner is typically responsible for processing write operations and maintaining the latest, authoritative version of the data. The log owner may insert data records into a local memory structure and separately store log records in the transaction log. As an example, if the log owner executes a SQL insert statement, then it inserts the specified data record(s) into the local memory structure and further stores, in the transaction log, a log record that identifies the execution of that SQL insert statement.

Log tailers are synchronized with the log owner to reflect its current state. In particular, the log tailers read the transaction log (particularly, the most recent log records (i.e., “tail” the log)) and replay operations that were performed by the log owner in order to reflect its current state. By tailing the log, these log tailers can process read requests and, if need be, fail over to become the new log owner if the current log owner crashes or otherwise becomes unavailable. Since the log tailers are allowed to process read requests and only the log owner is allowed to process write requests, the conventional leader-follower architecture can scale well for reads but not writes. In order to scale writes, in various embodiments described below, log tailers are permitted to process write requests (e.g., inserts, updates, etc.) . As a part of processing a write request, a log tailer may perform the processing involved in determining what records to write and then instruct the log owner to insert the record(s) into its local memory structure and also log the write operations in the transaction log.

For various database system architectures, semantics demand that, when a record in a table is updated, this update must be made based on the latest/newest version of the record that exists in the database and not any previous versions. In various embodiments described herein, records are immutable and therefore, to update a record, a new record has to be written. As a result, a database construct (e.g., a row in a table) can be associated with multiple records that are each a different version of the database construct—these records are referred to as “record versions” of that database construct and thus the term “record version” is used interchangeably with the term “record” unless indicated otherwise. As an example, a first record (a first record version) may initially be committed that stores certain values for a row in a database table and later a second record (a second record version) may be committed that updates one or more of the values of that row of the database table. As mentioned, for various architectures, semantics demand that the database node (more particularly, the database transaction) must observe the latest record version (e.g., the latest version of a row in a table) when generating a newer record version. If this rule is violated, then the database system raises an error that the record violation has occurred to ensure functional correctness.

A situation can arise where this rule is violated in architectures in which log tailers are permitted to process write requests. For example, the log owner and a log tailer may both store locally a first record associated with a particular database key. The log owner receives a request to write a second record associated with that particular database key, where the second record is a newer record version than the first record. The log owner writes that second record into its local memory structure and commits it. The log tailer may not observe the second record until it has replayed the write operation from the transaction log. The log tailer receives a request to write a third record associated with the particular database key, generates the third record after observing the first record in its local memory structure, and provides the third record to the log owner. The log owner commits the third record, violating the rule since the log tailer did not observe the second record when generating the third record and the log owner was not aware. Record violations of the rule can lead to database corruption—e.g., a violation might result in dangling index records. This disclosure addresses, among other things, the problem of how to detect and prevent these record violations.

In various embodiments described below, a database system comprises a log owner and one or more log tailers. The log owner maintains a transaction log and the log tailers replay the transaction log. A log tailer may receive a request to perform a database operation that involves writing a record—e.g., the transaction may update a row in a database table stored in a database of the database system. In various embodiments, the log tailer generates the record and includes lineage information that identifies a previous version of that record that was observed by the log tailer when generating the record. The log tailer issues a request (having the record) to the log owner to log the database operation in the transaction log. Before inserting the record into a local memory structure of the log owner (e.g., an in-memory cache) and logging the database operation in the transaction log, in various embodiments, the log owner determines, based on the lineage information of the record, whether a record violation has occurred where a previous version of the record has been committed that is a newer version than the one observed by the log tailer when it generated the record for the database operation. As a part of this process, the log owner may check its local memory structure for any committed record versions newer than the record version that was observed by the log tailer. In response to determining that the record violation has occurred, the log owner prevents the database operation from being logged in the transaction log and may return an error to the log tailer. Otherwise, the log owner may insert the record into its local memory structure and log the database operation in the transaction log, as requested.

In some cases, newer versions of the record than the version observed by the log tailer are not located in the log owner's memory structure; rather, those newer versions may be stored in a storage repository shared between the log owner and the log tailers. Those newer versions may be included in a log-structured merge tree (LSM tree) stored at the storage repository. In some embodiments, the log owner does not check this storage repository when its determining whether a violation has occurred due to, e.g., overhead costs. As a result, the log owner may not be aware of the latest version of a record and thus a newer version that is not based on the latest version may be committed that violates the aforementioned rule. To detect this violation, in various embodiments, when a compaction operation is performed on the LSM tree, the entity performing the compaction (e.g., the log owner) verifies the lineage information of the records involved in the compaction. If multiple records identify the same base record (i.e., the record observed by the log owner and/or the log tailer(s) that generated those records), then an error may be raised that a record violation has occurred.

These techniques may be advantageous over prior approaches as these techniques allow for record violations to be detected and potentially prevented. By including lineage information in records, the database system (e.g., the log owner) can detect a record that was not generated based on the latest record version (e.g., the log tailer did not observe the latest record version when it generated the record). As a result, the database system may prevent corruption in the database. As an example, when a log tailer executes a database statement to update a row of a table, the update may occur if one or more values of that row satisfy certain criteria. The latest committed record version of the row may include values that do not satisfy the criteria and thus the update to the row should not occur. But the log tailer may access a record version from a local memory structure that does satisfy the criteria and thus generate a new record version as a part of executing the database statement. If the record violation is not detected, then the new record version will be committed, causing corruption in the database. But by including lineage information in that new record version, the log owner may detect that this new record version is not based on the latest committed record version of the row and thus prevent the new record version from being committed.

Furthermore, in some embodiments, caching and filtering techniques are employed to allow individual database nodes (e.g., the log owner and the log tailers) to act as independently as possible and avoid cross-node communication if the latest version of a record is guaranteed to be available locally. As an example, a log tailer may use Bloom filters (or other probabilistic data structures) to determine that a new record version of a row has not been written by another database node in the database system. But these techniques can be prone to software bugs that lead to outdated records being used as the basis for modifications, especially on the log tailers. This can result in data loss and corruption. The techniques disclosed herein may act as a failsafe for these cases in which these are software bugs in the caching and filtering mechanisms. That is, even if a software bug causes a log tailer to mistakenly believe it accessed the latest record version when generating a new record version, including lineage information in the new record version can prevent the new record version from being committed.

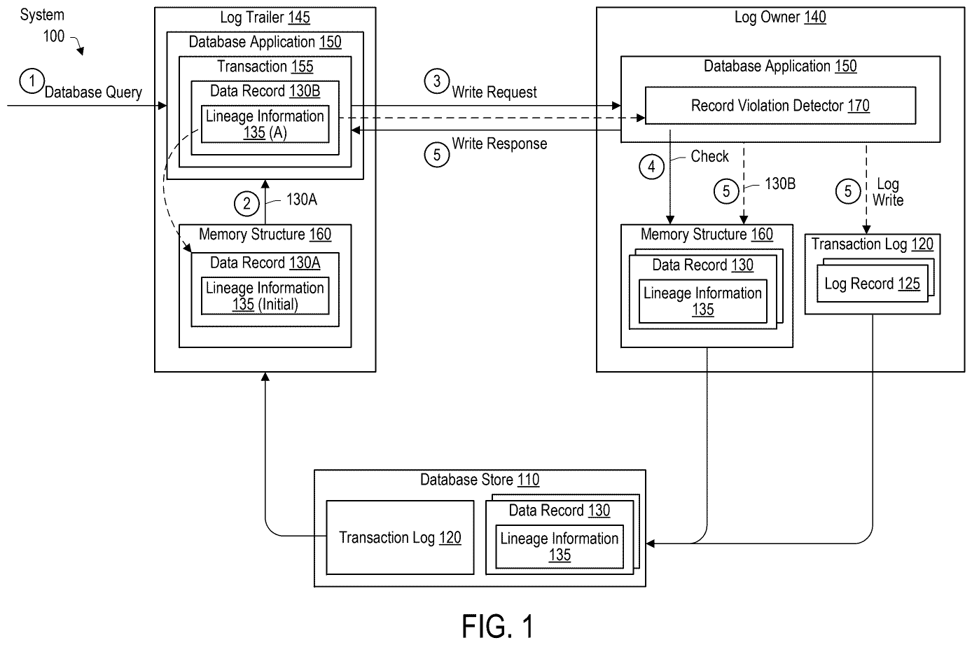

Turning now to FIG. 1, a block diagram of a system 100 is shown. System 100 includes a set of components that may be implemented via hardware or a combination of hardware and software. In the illustrated embodiment, system 100 includes a database store 110, a log owner 140, and a log tailer 145. As shown, log owner 140 and log tailer 145 each include an instance of a database application 150 and an instance of a memory structure 160 that stores data records 130. Also as shown, log owner 140 includes a transaction log 120 having log records 125, and database store 110 also includes an instance of transaction log 120—log tailer 145 also includes an instance of transaction log 120 in various embodiments, although not depicted in FIG. 1. As further shown, database store 110 stores data records 130 having lineage information 135. The illustrated embodiment may be implemented differently than shown. For example, system 100 can include multiple log tailers 145 that form a database cluster with log owner 140. Moreover, while record violation detector 170 is depicted as part of database application 150, a portion or all of record violation detector 170 may be implemented by log owner 140's memory structure 160. Furthermore, it is noted that the number of components of system 100 (and the number of subcomponents) may vary between embodiments. Thus, there can be more or fewer of each component or subcomponent than the number shown in FIG. 1

System 100, in various embodiments, implements a platform service (e.g., a customer relationship management (CRM) platform service) that allows users of that service to develop, run, and manage applications. System 100 may be a multi-tenant system that provides various functionality to users/tenants hosted by the multi-tenant system. Accordingly, system 100 may execute software routines from various, different users (e.g., providers and tenants of system 100) as well as provide code, web pages, and other data to users, stores, and other entities that are associated with system 100. In various embodiments, system 100 is implemented using a cloud infrastructure that is provided by a cloud provider. Thus, database store 110, log owner 140, and log tailer 145 may use the available cloud resources of the cloud infrastructure (e.g., computing resources, storage resources, etc.) in order to facilitate their operation. For example, software for implementing database application 150 can be stored on a non-transitory computer readable storage medium of server-based hardware that is included in a datacenter of the cloud provider and executed in a virtual machine that is hosted on the server-based hardware. Various components of system 100 may be implemented without the assistance of a virtual machine or other deployment technologies such as containerization. In some embodiments, system 100 is implemented using a local or private infrastructure as opposed to a public cloud.

Database store 110, in various embodiments, includes a collection of data organized in a manner that allows for access, storage, and manipulation of the data. Database store 110 may include supporting software (e.g., storage nodes) that enables database nodes (e.g., log owner 140 and log tailer 145) to carry out the operations (e.g., accessing, storing, etc.) on data that is stored at database store 110. In various embodiments, database store 110 is implemented using a single or multiple storage devices connected together on a network (e.g., a storage attached network (SAN)) and configured to redundantly store data in order to prevent data loss. These storage devices may store data persistently and thus database store 110 may serve as persistent storage for system 100. Further, as discussed, components of system 100 may use the available cloud resources of a cloud infrastructure and thus database store 110 may be a storage service provided by a cloud provider (e.g., Amazon S3®). Also, the data written to database store 110 by one database node (e.g., log owner 140) may be accessible to other database nodes (e.g., log tailer 145) in a multi-node configuration (e.g., a node cluster or a system having multiple node clusters spread across different zones provided by a cloud provider).

In various embodiments, database store 110 stores at least two types of files: data files and log files. A data file may comprise the actual data and may be append-only such that new data records 130 are appended to the data file until its size reaches a threshold and another data file is created. A data record 130, in various embodiments, comprises data and a database key that is usable to look up that data record 130. For example, a data record 130 may correspond to a row in a database table, where the record specifies values for attributes of the table. A log file may comprise log records 125 that describe database modifications (e.g., record insertions) resulting from executing database transactions 155. As with data files, log files may be append-only and continuously receive appends as transactions 155 do work. In various embodiments, transaction log 120 is a set of log files having log records 125 that collectively identify a state of the database system implemented by system 100. Transaction log 120 may thus record every change (inserts, updates, deletes) made to the database stored at database store 110. By reading transaction log 120, a database node (e.g., log tailer 145) may determine an ordering in which database operations were performed in system 100, including an ordering in which transactions 155 committed. Data files and log files, in various embodiments, are assigned file IDs that can be used to locate them. Log owner 140 and log tailer 145 may access data records 130 and log records 125 from database store 110 by issuing access requests with file IDs to storage nodes that implement database store 110.

Log owner 140 and log tailer 145, in various embodiments, are database nodes that can facilitate database services, such as data retrieval and/or data storage. In various embodiments, database nodes are software, but in other embodiments, they encompasses both hardware and software. A database node may operate in at least two different modes: a primary or log owner mode and a secondary or log tailer mode. Thus, in the illustrated embodiment, log owner 140 is a database node that operates in the log owner mode while log tailer 145 is a database node that operates in the log tailer mode. If log owner 140 crashes or otherwise becomes unavailable, then the database node that operates as log tailer 145 may transition to the log owner mode and therefore operate as the next log owner 140 as a result.

Log owner 140, in various embodiments, is responsible for generating and maintaining transaction log 120. Log owner 140 may thus manage the persistence of log records 125 (e.g., by storing them at database store 110) and ensure that they are available for other components, such as log tailer 145, to access. Log tailer 145, in various embodiments, reads transaction log 120 (particularly, the most recent log records 125) and replays read log records 125 to recreate the state of the log owner's memory structure 160. Log tailer 145 may access transaction log 120 from database store 110 (particularly, the most recent log records 125 after log owner 140 has written them to database store 110), store a local instance of transaction log 120, and replay log records 125 from it. As a result of replaying log records 125, log tailer 145 may be able to return data records 130 from its memory structure 160 as a part of processing transactions 155 and, in the event that log owner 140 becomes unavailable (e.g., crashes), become the next log owner of transaction log 120.

In various embodiments, log owner 140 and log tailer 145 implement a database system together. This database system may be a relational database system, such as PostgreSQL®. In various embodiments, log owner 140 and log tailer 145 implement a multi-tenant system that allows multiple tenants to each store a respective set of data in database store 110. For example, database store 110 may store a first set of data for a non-profit organization (a first tenant) and a second set of data for a company (a second tenant). In that embodiment, the database system implemented by log owner 140 and log tailer 145 may employ security measures to ensure that one tenant's data is isolated from another's data to prevent one tenant from accessing another tenant's data (without authorization).

Database services of log owner 140 and log tailer 145 may be provided to components within or external to system 100. As an example, log owner 140 may receive database requests from a client application to perform one or more database operations for a database transaction 155. A database transaction 155, in various embodiments, is a logical unit of work (e.g., one or more database statements). For example, processing a database transaction 155 may include executing a SQL select statement to select and return one or more rows from a database table. The contents of a row may be specified in a data record 130 and therefore log owner 140 may return one or more data records 130 (corresponding to the rows) to the client application. The database requests received by log owner 140 and/or log tailer 145 may include a set of database statements expressed using SQL or another query declarative language.

Database application 150, in various embodiments, is software executable to provide a set of database services (e.g., access, manipulate, and/or store data). Thus, database application 150 can receive database statements (e.g., a SQL select statement) as part of executing database transactions 155 and process them. To process a database statement, database application 150 may execute a query plan (also referred to as an “execution plan”) that defines a sequence of steps to be executed to implement that database statement. In various embodiments, database application 150 may generate one or more query plans, select one of them based on a scoring mechanism, and execute the selected query plan, all within a single execution flow (e.g., that is triggered by a request to execute a database statement). In some cases, database application 150 may receive a request to generate one or more query plans for a database statement and separately receive a request to execute the database statement with certain values in accordance with one of the query plans. As part of executing a database statement, in various embodiments, database application 150 may generate data records 130 and also log records 125 if executing on log owner 140. Database application 150 may temporarily store data records 130 in its local memory structure 160.

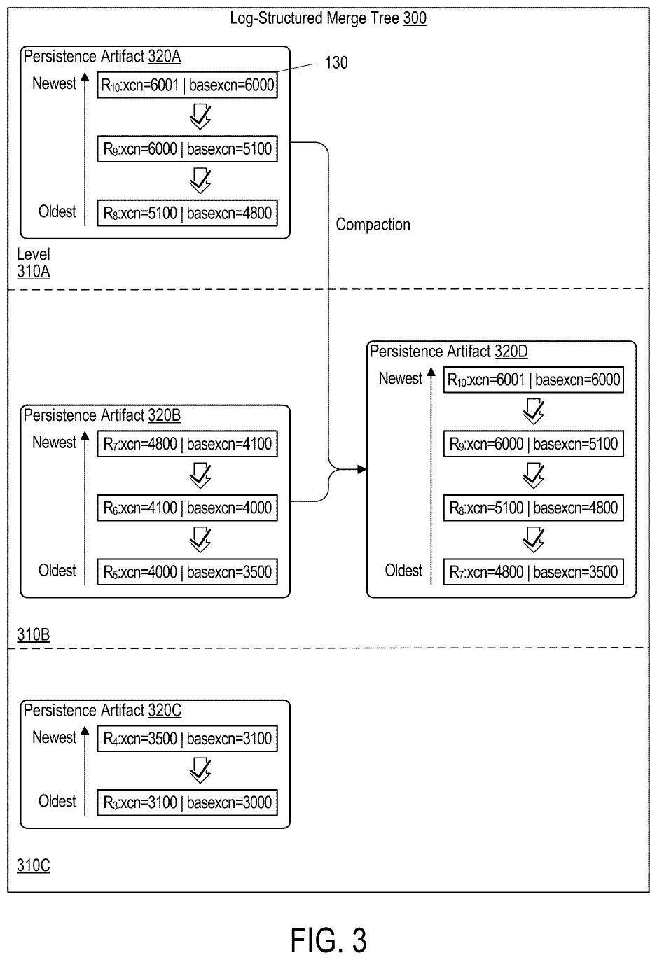

Memory structure 160, in various embodiments, is an in-memory buffer that stores data (e.g., data records 130) in memory (e.g., random access memory) before being written to disk. HBase™ Memstore is one example of memory structure 160. In various embodiments, data records 130 are stored in persistence artifacts (e.g., files) as part of a log-structured merge tree (LSM tree) that organizes them using a level-based scheme. In particular, database application 150 may initially insert data records 130 into memory structure 160. As memory structure 160 becomes full or after certain periods of time, database application 150 may flush data records 130 from its memory structure 160 to database store 110. That is, memory structure 160 may hold recent record versions until enough data has been accumulated to create a new persistence artifact. As a part of flushing those data records 130, database application 150 may write them into a new persistence artifact that is stored in one of the multiple levels (e.g., the top level) of the LSM tree. Over time, those data records 130 are rewritten into new persistence artifacts stored in lower levels as they are merged down the LSM tree as part of compaction operations, discussed in more detail with respect to FIG. 3.

All data records 130 that are generated as a result of data manipulation language (DML) statements may be inserted into log owner 140's memory structure 160, which may implement logic to manage locks and insertions, updates, and deletions. Accordingly, log owner 140 may populate its memory structure 160 based on its own work and the work done by log tailer 145 when executing database transactions 155. Log tailer 145 may populate its memory structure 160 when replaying transactions 155 recorded in transaction log 120—in some embodiments, log tailer 145 can insert, before replaying transaction log 120, data records 130 into its memory structure 160 after receiving a write response from log owner 140 indicating that the database operations associated with those records have been logged. In various embodiments, when log tailer 145 flushes its memory structure 160, it may evict data records 130 without writing them out to database store 110 because those records may already be stored at database store 110 as a result of a flush by log owner 140.

In various embodiments, log tailer 145 processes both read and write transactions 155, where a write transaction can involve both reading and writing data records 130. Accordingly, log tailer 145 may process a write transaction 155 involving at least a write operation (e.g., a SQL insert, a SQL update, etc.) to write a data record 130. Log tailer 145 may initially receive a set of database queries (as shown) for such a write transaction 155. When processing a write operation, log tailer 145, in various embodiments, determines what data records 130 to write for that write operation. In many cases, writing a data record 130 for a database table may also involve writing one or more additional data records 130. As an example, writing a data record 130 that represents a new purchase of an item may also involve updating an inventory of that item. As another example, there may be one or more indexes built on a database table. Updating a base data record 130 of the database table may also involve updating the indexes, particularly the entries related to that base data record 130, which results in one or more additional records 130.

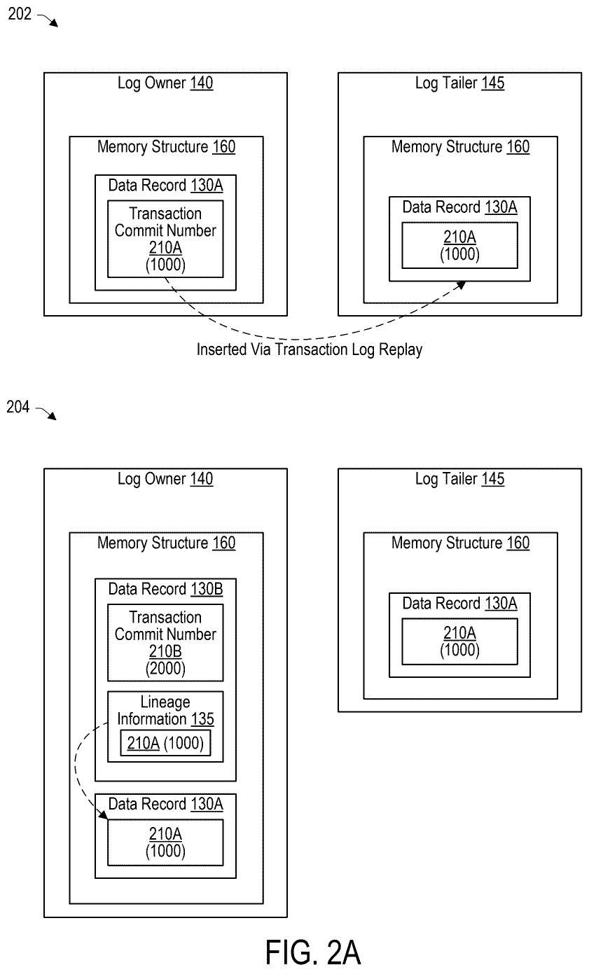

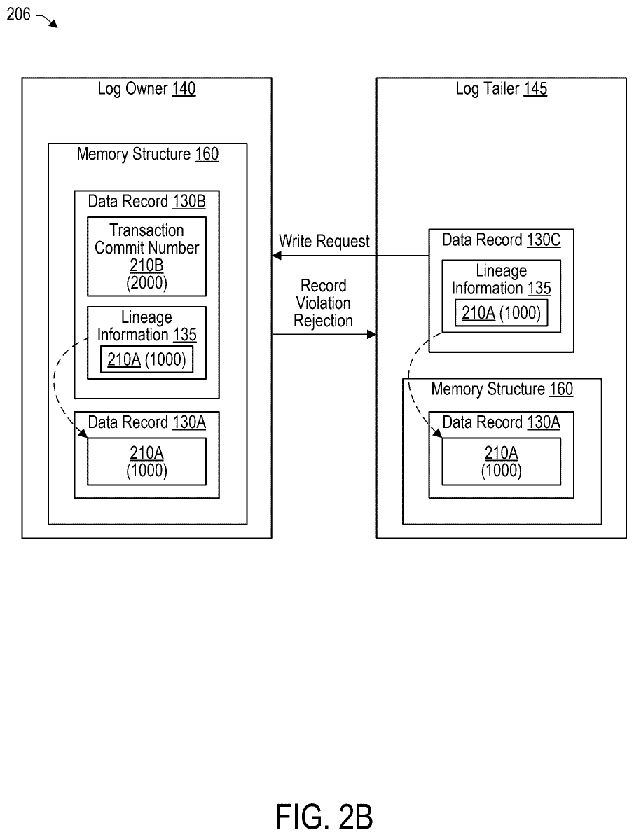

When writing a data record 130 that is a new record version (e.g., for a row in a table), in various embodiment, a database node (e.g., log tailer 145) accesses the latest record version from its memory structure 160 or database store 110. In particular, log tailer 145 may initially check its memory structure 160 for the latest record version. If its memory structure 160 does not store a record version, then log tailer 145 may access the latest record version from database store 110. But in some cases, its memory structure 160 may store a record version that is not the latest record version, but log tailer 145 believes it is the latest record version. Accordingly, log tailer 145 may generate one or more data records 130 based on a record version that is not the latest record version, resulting in a record violation, as discussed. An example scenario is discussed in greater detail with respect to FIGS. 2A and 2B. In order to prevent this scenario, in various embodiments, log tailer 145 includes lineage information 135 in data records 130 that it generates when executing database transactions 155.

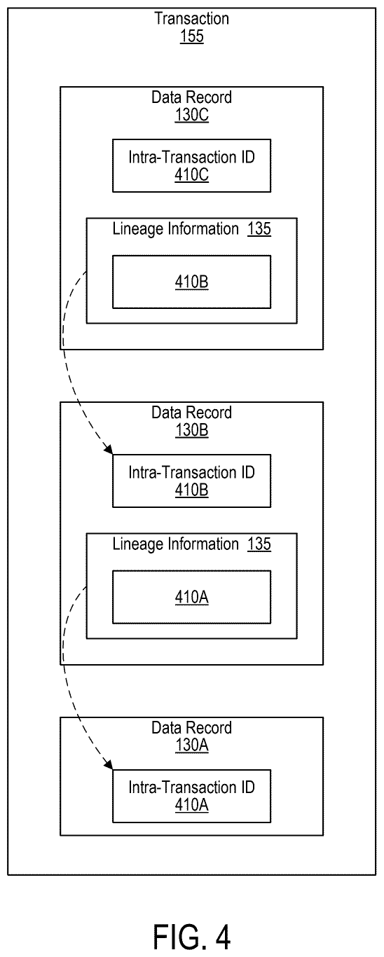

Lineage information 135, in various embodiments, identifies a previous record version that was observed by an entity (e.g., log tailer 145) when generating a new record version. For example, log tailer 145 may execute a transaction 155 to update a row in a database table that is identified by a particular database key. In the illustrated embodiment, log tailer 140 stores a data record 130A in its memory structure 160. For this example, data record 130A corresponds to a record version associated with the row. Log tailer 140 may access data record 130A from memory structure 160 and generate a data record 130B based on data record 130A. As shown, data record 130B includes lineage information 135 that identifies data record 130A since data record 130A served as the basis for data record 130B—data record 130B's lineage information 135 indicates that log tailer 145 believes data record 130A to be the latest record version of the row that is being updated. As discussed in more detail with respect to FIGS. 2A and 2B, lineage information 135 may specify the transaction commit number assigned to data record 130A. As discussed in more detail with respect to FIG. 4, for intra-transaction writes, lineage information 135 may specify a combination of a transaction ID and a sequence number.

After log tailer 145 determines what data records 130 to write for a write operation, in various embodiments, log tailer 145 issues a write request (as shown) to log owner 140 to insert the determined data records 130 (e.g., data record 130B) into its memory structure 160 and log the write operation to transaction log 120. Before inserting the received data records 130 into memory structure 160, in various embodiments, log owner 140 (particularly, record violation detector 170) detects whether there are any record violations. In various embodiments, record violation detector 170 is software that is executable to determine, for a given data record 130, whether a newer record version has been committed that is a newer version than the record version that was observed by the entity who generated the given data record 130. For example, before inserting data record 130B into memory structure 160, record violation detector 170 determines whether there is a newer committed record version than data record 130A because data record 130B's lineage information 135 identifies data record 130A.

As new record versions are inserted into log owner 140's memory structure 160 as part of update operations, a new record version may still be present. Accordingly, record violation detector 170 checks log owner 140's memory structure 160 for newer record versions (e.g., for newer record versions than data record 130A). If record violation detector 170 does not locate any record versions in log owner 140's memory structure 160 or determines that a data record 130 was generated based on the newest record version (e.g., log owner 140's memory structure 160 stores data records 130A and it is the newest version), then, in various embodiments, the data record 130 (e.g., data record 130B) is inserted into log owner 140's memory structure 160 and the corresponding database operation is logged in transaction log 120. If record violation detector 170 detects a record violation for that data record 130, then the data record 130 is not inserted, the database operation is not logged, and a write response is returned that may specify an error pertaining to the record violation.

While record violation detector 170 is shown separately from log owner 140's memory structure 160, in various embodiments, record violation detector 170 is implemented as part of log owner 140's memory structure 160. Accordingly, when database application 150 attempts to insert a data record 130 into memory structure 160, record violation detector 170 may detect whether a record violation has occurred and return a rejection response to database application 150 if there is a record violation. Based on the response returned to database application 150, database application 150 may provide a corresponding write response to log tailer 145. If the write response indicates that a record violation has occurred, in some embodiments, log tailer 145 replays the database statement associated with the data record 130.

Turning now to FIG. 2A, a block diagram of a first part of an example in which a record violation is detected by log owner 140 is shown. In the illustrated embodiment, this first part of the example involves stages 202 and 204. As depicted in stage 202, there is log owner 140 and log tailer 145, each with an instance of memory structure 160. As further shown, log tailer 145 inserts a data record 130A into its memory structure 160 as part of replaying a transaction 155 recorded in transaction log 120. In particular, log owner 140 may execute a transaction 155 that involves writing data record 130A or it may receive a request (e.g., from log tailer 145) to write data record 130A and log the write in transaction log 120. Accordingly, log owner 140 may insert data record 130A into its memory structure 160 and log the write in transaction log 120. When committing the associated transaction 155, log owner 140 may log the commit in transaction log 120 and, once the commit is durable, stamp data records 130 associated with the transaction with a transaction commit number 210.

A transaction commit number 210, in various embodiments, is a unique number that is indicative of when a transaction 155 was committed. System 100 may increment a commit number over time (i.e., as progress is made within system 100) and thus a series of transaction commit number 210 may be used to represent the progression of time in system 100. In various embodiments, when a transaction 155 is being committed, its data records 130 are stamped with a transaction commit number 210 assigned to the transaction 155. As shown for example, data record 130A is stamped with a transaction commit number 210A of 1000. A data record 130 committed earlier in time is stamped with a transaction commit number 210 that has a smaller numerical value than the transaction commit number 210 of a data record 130 that is committed at a later time. As a result, by looking at the transaction commit numbers 210 of a set of data records 130, log owner 140 and log tailer 145 can determine the order in which the data records 130 were committed. Accordingly, transaction commit numbers 210 may be used to determine which data record 130 is the newest record version between multiple data records 130. As an example, a row in a table may be associated with a first data record 130 that has a transaction commit number 210 of 450 and a second data record 130 that has a transaction commit number 210 of 320. As such, log owner 140 and log tailer 145 can determine that the first data record 130 is the newer record version because it has the greater transaction commit number 210 (i.e., 450>320).

After a transaction 155 has been committed, log owner 140 may provide a portion of transaction log 120 that corresponds to the transaction 155 to log tailer 145 (e.g., either directly or via database store 110—log owner 140 writes log records 125 to database store 110 and log tailer 145 accesses them). Log tailer 145 may replay the transaction 155 by performing the database operations recorded for the transaction 155 in order. As a result, log tailer 145 may insert the data records 130 associated with a database transaction 155 into its memory structure 160. Thus, as shown, log tailer 145 inserts data record 130A into its memory structure 160 via transaction log replay.

As shown in stage 204, there is log owner 140 and log tailer 145, each with an instance of memory structure 160 that stores data record 130A. As further shown, log owner 140 inserts a data record 130B into its memory structure 160. Log owner 140 may insert data record 130B into its memory structure 160 as part of executing a transaction 155 locally or in response to a write request from another log tailer 145 (not shown). For example, log owner 140 may execute a SQL update statement to update a row in a table, where data record 130A is a record version of that row. As shown, data record 130B is stamped with a transaction commit number 210B of 2000 (the commit number assigned to its transaction 155) and includes lineage information 135 specifying transaction commit number 210A. Data record 130B's lineage information 135 indicates that data record 130A was used as the basis when generating data record 130B. Said differently, in various embodiments, lineage information 135 identifies the transaction commit number 210 of the record version that was read at the time of an update or delete operation and was used as the basis to apply the effects of the update or delete operation. Lineage information 135 may be recorded on the node that processes the update or delete operation. It is noted that lineage information 135 may not be maintained for data records 130 that are created by insert operations as they are not based on an existing record versions. Also, in various embodiments, lineage information 135 may be included in data records 130 that correspond to rows of a table but not be included in data records 130 that are part of indexes.

Turning now to FIG. 2B, a block diagram of a second part of the example discussed in respect to FIG. 2A in which the record violation is detected by log owner 140 is shown. In the illustrated embodiment, this second part involves a stage 206. As shown in stage 206, there is log owner 140 and log tailer 145, each with an instance of memory structure 160. As further shown, log tailer 145's memory structure 160 includes data record 130A, and log owner 140's memory structure 160 includes data records 130A and 130B.

At stage 206, log tailer 145 creates a data record 130C having lineage information 135 that specifies transaction commit number 210A of data record 130A. Log tailer 145 may create data record 130C as part of executing a SQL update statement to update a row in a table, where data records 130A and 130B are record versions of that row. Data record 130C is created based on data record 130A found in log tailer 145's memory structure 160 instead of the newer record version (data record 130B) that is found in log owner 140's memory structure 160. Log tailer 145 may not be aware of data record 130B as it has not yet replayed the transaction 155 that is associated with data record 130B. Also, in various embodiments, log tailer 145 leverages data structures that allow it to determine whether there is potentially a newer record version stored by log owner 140. But software bugs in the logic associated with the data structures may result in log tailer 145 not being aware that there is a newer record version stored by log owner 140. As a result, log tailer 145 may believe data record 130A to be the newest record version of the table row, and thus creates record data record 130C based on data record 130A. Log tailer 145 issues a write request (as shown) to log owner 140 to insert data record 130C into its memory structure 160 and log the corresponding database operation in transaction log 120.

When attempting to insert data record 130C into its memory structure 160, in various embodiments, log owner 140 detects a lineage violation and raises an error because data record 130C's lineage information 135 references data record 130A instead of data record 130B (the latest committed version). In particular, since data record 130B is located in log owner 140's memory structure 160, log owner 140 is able to determine that there is a newer record version of the underlying database construct (e.g., a row in a table) than data record 130A. As a result, log owner 140 is able to determine, based on data record 130C's lineage information 135, that log tailer 145 did not observe the newest record version when it created data record 130C and thus a record violation has occurred. But in response to detecting that the record violation has not occurred (e.g., data record 130B does not exist), log owner 140 may then insert data record 130C into memory structure 160 and log the database operation in transaction log 120.

While the example discussed with respect to FIGS. 2A and 2B involves log owner 140 checking for record violations for records 130 that are generated by log tailer 145, in various embodiments, log owner 140 also checks for record violations for records 130 that it generates itself. When log owner 140 generates a record 130, it may include lineage information 135 in the record 130 and apply the same lineage checking when inserting the record 130 into its local memory structure 160. This lineage checking may be performed to provide a safe guard against software bugs that may occur at log owner 140, such as a software bug that causes log owner 140 to not observe the latest record version when generating a data record 130.

Turning now to FIG. 3, a block diagram of an example that pertains to persisting lineage information during a compaction operation on a log-structured merge tree 300 (LSM tree 300) is shown. In the illustrated embodiment, LSM tree 300 comprises levels 310A-C. Level 310A includes a persistence artifact 320A having three records R₈-R₁₀, level 310B initially includes a persistence artifact 320B having three records R₅-R₇, and level 310C includes a persistence artifact 320C having two records R₃-R₄. Records R₃-R₁₀ are record versions of an underlying database construct (e.g., a row in a table) and each record includes a basexcn that identifies the transaction commit number of the record that was read and used as the basis when that former record was created. The illustrated embodiment may be implemented differently than shown. For example, more than two levels 310 may be involved in a compaction operation.

LSM tree 300, in various embodiments, is a data structure storing persistence artifacts 320 in an organized manner that uses a level-based scheme. During operation, database nodes (e.g., log owner 140 and log tailer 145) may initially write data records 130 into their memory structures 160 before later flushing them to database store 110. As part of flushing data records 130, the database nodes may write the data records 130 to a new persistence artifact 320 stored at the top level 310 of LSM tree 300. A persistent artifact 320, in various embodiments, is a file that stores a set of data records 130 in key-sorted order based on their primary key. Over time, data records 130 are rewritten to new persistent artifacts 320 stored in lower levels 310 as those data records 130 are merged down LSM tree 300 as part of compaction operations, as discussed below.

A level 310, in various embodiments, is a storage area in which a set of records 130 are stored. In some embodiments, levels 310 correspond to different types of storage devices (e.g., solid state drives (SSDs), hard disk drives (HDDs), etc.), where lower levels 310 correspond to slower devices with higher storage capacity. For example, level 310A may be implemented using SSDs while lower levels 310B and 310C might be implemented using HDDs. Generally speaking, older data records 130 are stored in lower levels 310. As discussed above, in various embodiments, records 130 are immutable once written. Accordingly, to update the values of a record 130, a database node writes a new record 130 with the updated values that supersedes the older record 130. That older record 130, however, may continue to persist in the database. As a result, the same underlying construct (e.g., a row) can be associated with multiple record versions, with the latest version being located in a higher level 310 than the other, older record versions. As a data record 130 is superseded and becomes older, it may be copied to colder and colder storage as it is accessed less.

In various embodiments, log owner 140 and/or log tailer 145 can execute a compaction operation on LSM tree 300 to copy records 130 from a first level 310 into a second, lower level 310. During an LSM tree compaction operation, persistence is reorganized, and record versions that reside in different persistence artifacts 320 that may belong to different levels 310 of LSM tree 300 are combined into a single persistence artifact 320. Compaction may happen in a way such that multiple record versions are always seen in proper order and without any gaps in the sequence. This may allow for lineage checking within the range of record versions that is seen by that compaction operation.

As discussed, database nodes (e.g., log owner 140) may periodically flush data records 130 from their memory structure 160 to database store 110. Accordingly, data records 130 may not remain in a database node's memory structure 160 indefinitely. As data records 130 may not remain in its memory structure 160, log owner 140 may not have any knowledge about the previous version(s) of a data record 130. Consequently, log owner 140 may not detect a record violation when the previous version(s) are not stored within its memory structure 160. In some embodiments, log owner 140 may reach out to database store 110 to locate the newest version of a record 130. But this may incur high overhead costs. Accordingly, in various embodiments, lineage checking occurs in two places: when inserting a record into memory structure 160 and when performing a compaction operation on LSM tree 300.

When performing a compaction operation, in various embodiments, the database node determines whether there are multiple data records 130 that have lineage information 135 that refers to the same data record 130. For example, when compacting persistence artifacts 320A and 320B into persistence artifact 320D as depicted, the database node determines whether any of the records R₅-R₁₀ identify the same base transaction commit number 210 (basexcn). In the illustrated embodiment, none of the records R₅-R₁₀ identify the same basexcn and thus a record violation has not occurred. But if record R₈ identified 4000 as its basexcn instead of 4800 (for example), then the database node would detect a record violation since records R₇ and R₈ would have the same basexcn. If a record violation is detected, then an error may be sent to a database administrator to make them aware of the violation so that they can potentially remedy it.

In various embodiments, data records 130 are identified during compaction that are no longer accessible by database queries. In particular, system 100 may track the oldest snapshot transaction commit number in use. The latest record version at or below this commit number is preserved (if such a version exists), but older record versions may be pruned to reclaim space during a compaction operation. In various embodiments, when pruning during the compaction operation, the database node that is performing the compaction operation also performs lineage maintenance in order to maintain lineage checking invariants for each pruned data record 130. In particular, the database node may ensure that the oldest non-pruned data record 130 involved in the compaction operation is updated to refer to the basexcn of the oldest pruned data record 130.

Consider the illustrated embodiment in which a compaction operation is performed on artifacts 320A and 320B to produce artifact 320D. Assume for this compaction operation that the prune transaction commit number is 5000. In this example, records R₈-R₁₀ have transaction commit numbers above this prune commit number and records R₅-R₇ have transaction commit numbers below the prune commit number. Accordingly, records R₈-R₁₀ are not pruned. Since records R₇ is the latest record version at or below the prune commit number it is preserved but records R₅ and R₆ are pruned. Since records R₃ and R₄ are not part of the compaction operation, they may not be pruned during this compaction operation. In order to maintain a contiguous lineage between the record versions, in various embodiments, the oldest record version (record R₇ in the example) inherits the basexcn from the oldest pruned record version (record R₅ in the example). Thus, instead of record R₇ having lineage information that refers to a pruned record, record R₇'s lineage information is updated to refer to record R₄ so that, when a database node later checks for record violations, it will observe a contiguous lineage.

Turning now to FIG. 4, a block diagram of an example that pertains to tracking database record lineage across multiple records 130 generated for the same key by the same transaction 155. In the illustrated embodiment, transaction 155 involves writing data records 130A-C that are different record versions of the same underlying database construct (e.g., a row). It may be desirable to check for record violations between data records 130A-C to ensure that transaction 155 adheres to the lineage protocol—that is, to ensure that each record version is based on the immediate prior version (e.g., data record 130C is based on data record 130B). But transaction commit numbers 210 may not be used as lineage information 135 to differentiate those versions for an in-progress transaction since transaction commit numbers 210 are assigned and stamped on record versions at transaction commit time. For example, data record 130C cannot refer to data record 130B using a transaction commit number 210 while transaction 155 is in-progress since transaction 155 has not been assigned a transaction commit number 210.

Accordingly, intra-transaction IDs 410 may be used. In various embodiments, an intra-transaction ID 410 includes a combination of a transaction ID and an intra-transaction sequence number that uniquely identifies a data record 130. In particular, each transaction 155 executed by a database node (e.g., log tailer 145) may be assigned a transaction ID. The intra-transaction sequence number may correspond to a number of data records 130 created by a transaction 155 and therefore be incremented each time a data record 130 is created. In some cases, the intra-transaction sequence number may correspond to a number of versions of a data record 130 that is written by a transaction 155. As an example, intra-transaction ID 410A of data record 130A may specify “T1R1,” intra-transaction ID 410B of data record 130B may specify “T1R2,” and intra-transaction ID 410C of data record 130C may specify “T1R3.”

Because an intra-transaction ID 410 may uniquely identify a data record 130, in various embodiments, when multiple record versions are created for the same in-progress transaction 155, a newer record version refers to its base record version using the base record version's intra-transaction ID 410. For example, data record 130A is assigned intra-transaction ID 410A. Transaction 155 creates a newer record version, data record 130B, based on data record 130A and therefore specifies intra-transaction ID 410A in data record 130B's lineage information 135. Similarly, transaction 155 creates a newer record version, data record 130C, based on data record 130B and specifies data record 130B's intra-transaction ID 410B in data record 130C's lineage information 135.

When record versions belonging to the same transaction 155 are provided to log owner 140 as part of write requests, in various embodiments, log owner 140 determines whether any record violations have occurred based on their lineage information 135. Log owner 140 may determine whether two or more data records 130 refer to the same intra-transaction ID 410. If a record violation is detected, then log owner 140 may not insert the relevant data record 130 into its memory structure 160 and not log the database operation in transaction log 120. But if no record violation is detected then log owner 140 may insert the relevant data record 130 into its memory structure 160 along with logging the database operation in transaction log 120.

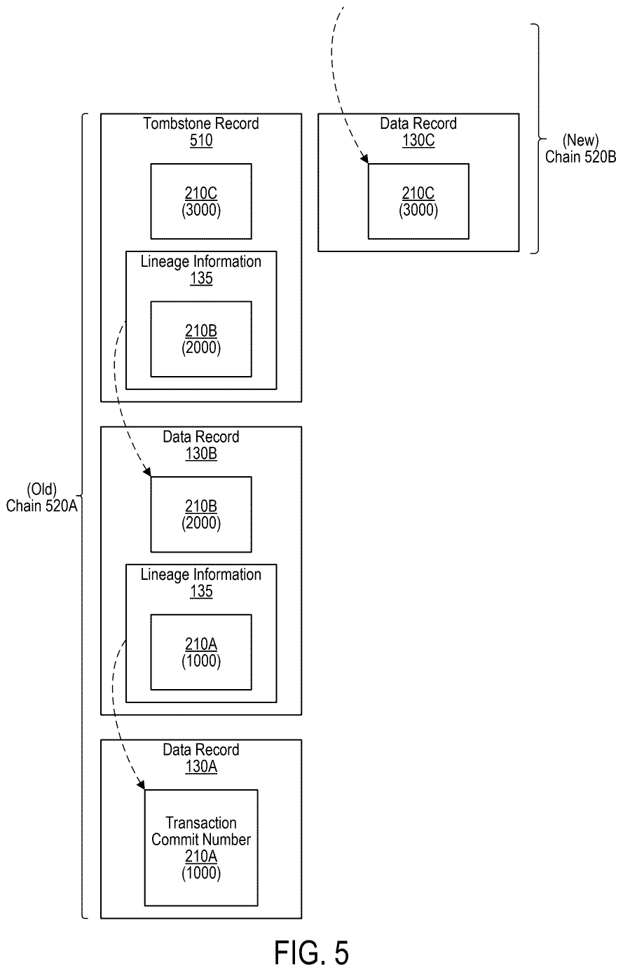

Turning now to FIG. 5, a block diagram of an example in which a record lineage chain 520 ends and a new record lineage chain 520 begins is shown. In the illustrated embodiment, there are two record lineage chains 520A and 520B. Also as shown, record lineage chain 520A includes a tombstone record 510 and data records 130A and 130B, while record lineage chain 520B includes a data record 130C. The illustrated embodiment may be implemented differently than shown. For example, tombstone record 510 may not include lineage information 135.

A database operation (e.g., a SQL update) may involve an update to the primary key of a data record 130. Accordingly, a new data record 130 with the new primary key may inserted into the database as part of the database operation. But in order to prevent the prior data record 130 from being accessed via the old primary key, in various embodiments, a tombstone record 510 is written. A tombstone record 510, in various embodiments, marks the deletion of records 130 that are 1) associated with a particular primary key and 2) older than that tombstone record 510. Accordingly, accesses to data records 130 associated with the particular primary key will observe that tombstone record 510 and thus not return data records 130 that are associated with the particular primary key and older than that tombstone record 510.

In various embodiments, database operations that involve an update to the primary key of a data record 130 affect the record's lineage. In particular, the tombstone record 510 that is produced by such database operations may mark the end of the record's lineage while the new, inserted data record 130 marks the beginning of a new record lineage. For example, a database operation may be performed that results in the illustrated tombstone record 510 and data record 130C. As shown, tombstone record 510 marks the end of record lineage chain 520A, and data record 130C marks the beginning of record lineage chain 520B. Record lineage chain 520B is a new, distinct lineage from record lineage chain 520—data record 130C does not reference tombstone record 510, and data record 130C may not include lineage information 135 because it is the first/genesis record in the new lineage chain. A subsequent record write that uses the updated primary database key associated with record lineage chain 520B may be connected to data record 130C via lineage information 135.

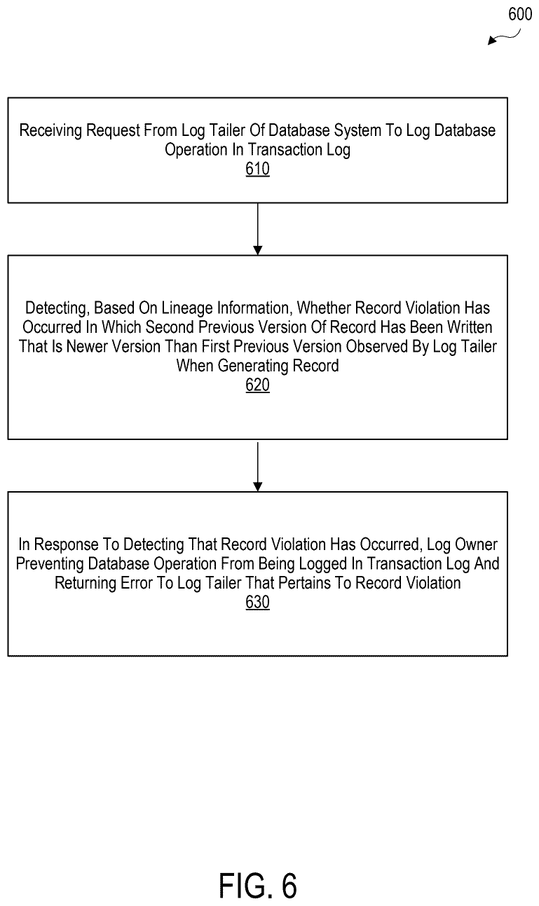

Turning now to FIG. 6, a flow diagram of a method 600 is shown. Method 600 is one embodiment of a method that is performed by a computer system (e.g., a computer system that implements log owner 140) to detect a record violation based on lineage information. Method 600 may be performed by executing program instructions stored on a non-transitory computer-readable medium. Method 600 may include more or fewer steps than shown. As an example, method 600 may include a step in which the computer system writes one or more records (e.g., data records 130) into a local memory structure (e.g., a memory structure 160).

Method 600 begins in step 610 with the computer system receiving a request from a log tailer (e.g., log tailer 145) to log a database operation (e.g., a SQL update) in a transaction log (e.g., transaction log 120). The computer system implements a log owner that maintains the transaction log, and the log tailer is a replica node that replays the transaction log. The request may include a record resulting from the database operation, and the record includes lineage information (e.g., lineage information 135) that identifies a first previous version of the record observed by the log tailer when generating the record. In various embodiments, the lineage information specifies a transaction commit number (XCN) (e.g., a transaction commit number 210) of the first previous version.

In step 620, the computer system detects, based on the lineage information, whether a record violation has occurred in which a second previous version of the record has been committed that is a newer version than the first previous version observed by the log tailer when generating the record. In various embodiments, the computer system stores, in a memory structure (e.g., a memory structure 160) of the computer system, a plurality of records resulting from database operations performed by the computer system and the log tailer. Accordingly, the computer system may check the memory structure for a newer version of the record than the first previous version observed by the log tailer when generating the record.

In some cases, the plurality of records may include a first set of records resulting from record update operations (e.g., SQL updates) and a second set of records resulting from record insert operations (e.g., SQL inserts). The first set of records includes lineage information while the second set of records does not include lineage information. In some cases, the plurality of records may include a first set of records of a database table and a second set of records of one or more indexes built on the database table. The first set of records (the table records) includes lineage information while the second set of records (the index records) does not include lineage information.

In step 630, in response to detecting that the record violation has occurred, the computer system prevents the database operation from being logged in the transaction log and returns an error to the log tailer that pertains to the record violation. In response to receiving a request to perform a particular database operation, the computer system may store, in the local memory structure, the second previous version of the record that is a newer version than the first previous version. Accordingly, the record violation may be detected based on the computer system observing the second previous version when checking the memory structure. In some embodiments, the computer system determines whether a storage repository (e.g., database store 110) that is shared between the computer system and the log tailer stores a newer version of the record than the first previous version. Thus, the record violation may be detected based on the storage repository storing a newer version of the record than the first previous version. In some embodiments, the record violation is detected based on the computer system observing a previous version of the record that has a greater XCN than the first previous version.

In response to detecting that the record violation has not occurred, the computer system may log the database operation in the transaction log and returns a success response to the log tailer. In some embodiments, a database system implemented by the computer system and the log tailer stores an LSM tree (e.g., LSM tree 300) having a plurality of records resulting from database operations performed by the computer system and the log tailer. The computer system may perform a compaction operation that involves a set of records stored across at least two levels of the LSM tree. In various embodiments, performing the compaction operation includes checking lineage information of particular records of the set of records to detect whether record violations have occurred for the particular records. The computer system may remove a subset of the plurality of records from the LSM tree, where those records of the subset correspond to different versions of a particular record. As part of removing the records, the computer system may update lineage information of a particular version (e.g., the oldest non-pruned record version) of the particular record to identify an oldest version of the particular record specified in lineage information of the subset of records (e.g., specified in the lineage information of the oldest pruned record version). In various embodiments, the computer system performs intra-transaction lineage checking for a database transaction to detect, based on lineage information included in different versions of a record written by the database transaction, whether a record violation has occurred for any of the different versions.

### Exemplary Computer System

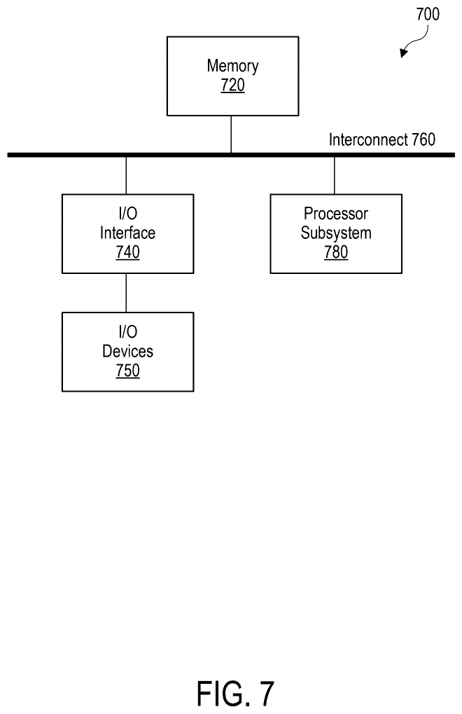

Turning now to FIG. 7, a block diagram of an exemplary computer system 700, which may implement system 100, database store 110, log owner 140, and/or log tailer 145, is shown. Computer system 700 includes a processor subsystem 780 that is coupled to a system memory 720 and I/O interfaces(s) 740 via an interconnect 760 (e.g., a system bus). I/O interface(s) 740 is coupled to one or more I/O devices 750. Although a single computer system 700 is shown in FIG. 7 for convenience, system 700 may also be implemented as two or more computer systems operating together.

Processor subsystem 780 may include one or more processors or processing units. In various embodiments of computer system 700, multiple instances of processor subsystem 780 may be coupled to interconnect 760. In various embodiments, processor subsystem 780 (or each processor unit within 780) may contain a cache or other form of on-board memory.

System memory 720 is usable store program instructions executable by processor subsystem 780 to cause system 700 perform various operations described herein. System memory 720 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 700 is not limited to primary storage such as memory 720. Rather, computer system 700 may also include other forms of storage such as cache memory in processor subsystem 780 and secondary storage on I/O Devices 750 (e.g., a hard drive, storage array, etc.). In some embodiments, these other forms of storage may also store program instructions executable by processor subsystem 780. In some embodiments, program instructions that when executed implement database store 110, database application 150, and/or memory structure 160 may be included/stored within system memory 720.

I/O interfaces 740 may be any of various types of interfaces configured to couple to and communicate with other devices, according to various embodiments. In one embodiment, I/O interface 740 is a bridge chip (e.g., Southbridge) from a front-side to one or more back-side buses. I/O interfaces 740 may be coupled to one or more I/O devices 750 via one or more corresponding buses or other interfaces. Examples of I/O devices 750 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 700 is coupled to a network via a network interface device 750 (e.g., configured to communicate over WiFi, Bluetooth, Ethernet, etc.).

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,”“an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
receiving, by a log owner of a database system, a request from a log tailer of the database system to log a database operation in a transaction log, wherein the log owner maintains the transaction log and the log tailer is a replica node that replays the transaction log, wherein the request includes a first record resulting from the database operation, and wherein the first record includes lineage information that identifies a first previous version of the first record that was observed by the log tailer when generating the first record;
detecting, by the log owner based on the lineage information, whether a record violation has occurred in which a second previous version of the first record has been committed that is a newer version than the first previous version observed by the log tailer when generating the first record; and
in response to detecting that the record violation has occurred, the log owner preventing the database operation from being logged in the transaction log and returning an error to the log tailer that pertains to the record violation.

2. The method of claim 1, further comprising:
storing, by the log owner in a memory structure of the log owner, a plurality of records resulting from database operations performed by the log owner and the log tailer, wherein the detecting includes checking the memory structure for a newer version of the first record than the first previous version observed by the log tailer when generating the first record.

3. The method of claim 2, further comprising:
in response to receiving a request to perform a particular database operation, the log owner storing, in the memory structure, the second previous version of the first record that is a newer version than the first previous version, wherein the record violation is detected based on observing the second previous version when checking the memory structure.

4. The method of claim 2, wherein the plurality of records includes a first set of records resulting from record update operations and a second set of records resulting from record insert operations, and wherein the first set of records includes lineage information while the second set of records does not include lineage information.

5. The method of claim 2, wherein the plurality of records includes a first set of records of a database table and a second set of records of one or more indexes created based on the database table, and wherein the first set of records includes lineage information while the second set of records does not include lineage information.

6. The method of claim 1, wherein the detecting includes:
determining whether a storage repository that is shared between the log owner and the log tailer stores a newer version of the first record than the first previous version, wherein the record violation is detected based on the storage repository storing a newer version of the first record than the first previous version.

7. The method of claim 1, wherein the database system stores a log-structured merge tree (LSM tree) that includes a plurality of records resulting from database operations performed by the log owner and the log tailer, and wherein the method further comprises:
performing a compaction operation that involves a set of records stored across at least two levels of the LSM tree, wherein the performing includes checking lineage information of particular records of the set of records to detect whether record violations have occurred for the particular records.

8. The method of claim 7, further comprising:
removing a subset of the plurality of records from the LSM tree, wherein the subset of records correspond to different versions of a particular record, and wherein the removing includes updating lineage information of a particular version of the particular record to identify an oldest version of the particular record that is specified in lineage information of the subset of records.

9. The method of claim 1, further comprising:
performing, by the log owner, intra-transaction lineage checking for a particular database transaction to detect, based on lineage information included in different versions of a record written by the particular database transaction, whether a record violation has occurred for any of the different versions.

10. The method of claim 1, wherein the lineage information specifies a transaction commit number (XCN) of the first previous version, and wherein the record violation is detected based on the log owner observing a previous version of the first record that has a greater XCN than the first previous version.

11. A non-transitory computer-readable medium having program instructions stored thereon that are capable of causing a computer system to implement a log owner that performs operations comprising:
receiving a request from a first log tailer of a database system to log a first database operation in a transaction log, wherein the log owner maintains the transaction log and the first log tailer is a replica node that replays the transaction log, wherein the request includes a first record resulting from the first database operation, and wherein the first record includes lineage information that identifies a first previous version of the first record that was observed by the first log tailer when generating the first record;
detecting, based on the lineage information, whether a record violation has occurred in which a second previous version of the first record has been committed that is a newer version than the first previous version observed by the first log tailer when generating the first record; and
in response to detecting that the record violation has occurred, preventing the first database operation from being logged in the transaction log and returning an error to the first log tailer that pertains to the record violation.

12. The non-transitory computer-readable medium of claim 11, wherein the operations further comprise:
in response to detecting that the record violation has not occurred, inserting the first record into a memory structure of the computer system and logging the first database operation in the transaction log.

13. The non-transitory computer-readable medium of claim 11, wherein the operations further comprise:
receiving a request from a second log tailer of the database system to log a second database operation in the transaction log, wherein the request from the second log tailer includes a second record that is a newer version than the first previous version of the first record; and
inserting the second record into a memory structure of the computer system, wherein the record violation is detected based on observing the second record in the memory structure during the detecting.

14. The non-transitory computer-readable medium of claim 11, wherein the operations further comprise:
performing a compaction operation that involves a plurality of records stored across at least two levels of a log-structured merge tree, wherein the performing includes checking lineage information of particular records of the plurality of records to detect whether record violations have occurred for the particular records.

15. The non-transitory computer-readable medium of claim 11, wherein a particular database transaction involves writing different versions of a record, and wherein the operations further comprise:
detecting, based on lineage information included in the different versions, whether a record violation has occurred for any of the different versions.

16. A system, comprising:
at least one processor; and
memory having program instructions stored thereon that are executable by the at least one processor to cause the system to perform operations comprising:
receiving a request from a log tailer to log a database operation in a transaction log, wherein the request includes a record resulting from the database operation, and wherein the record includes lineage information that identifies a first previous version of the record that was observed by the log tailer when generating the record;
detecting, based on the lineage information, whether a record violation has occurred in which a second previous version of the record has been committed that is a newer version than the first previous version observed by the log tailer when generating the record; and
in response to detecting that the record violation has occurred, preventing the database operation from being logged in the transaction log and returning an error to the log tailer that pertains to the record violation.

17. The system of claim 16, wherein the operations further comprise:
in response to detecting that the record violation has not occurred, inserting the record into a memory structure of the system and logging the database operation in the transaction log.

18. The system of claim 16, wherein the operations further comprise:
storing a plurality of records resulting from database operations performed by a log owner and a plurality of log tailers, wherein the detecting includes checking ones of the plurality of records for a newer version of the record than the first previous version observed by the log tailer when generating the record.

19. The system of claim 18, wherein the plurality of records includes a first set of records resulting from record update operations and a second set of records resulting from record insert operations, and wherein the first set of records includes lineage information while the second set of records does not include lineage information.

20. The system of claim 16, wherein the operations further comprise:
performing a compaction operation that involves a plurality of records stored across at least two levels of a log-structured merge tree, wherein the performing includes checking lineage information of particular records of the plurality of records to detect whether record violations have occurred for the particular records.
